(19) United States
(12) Patent Application Publication
(10) Pub. No.: US 2015/0058111 A1
(43) Pub. Date: Feb. 26, 2015

(54) METHOD AND SYSTEM FOR MEMBERSHIP RECRUITMENT THROUGH VALUE SENDING

(71) Applicants: Chi Ho Lee, Hong Kong (HK); Chi Ming Darius Lau, Hong Kong (HK); King Yiu Fung, Hong Kong (HK)

(72) Inventors: Chi Ho Lee, Hong Kong (HK); Chi Ming Darius Lau, Hong Kong (HK); King Yiu Fung, Hong Kong (HK)

(73) Assignee: Value Exchange International Limited, Hong Kong (HK)

(21) Appl. No.: 14/386,822

(22) PCT Filed: Jun. 19, 2012
(86) PCT No.: PCT/CN2012/077133

§ 371 Date: Sep. 22, 2014

(51) Int. Cl. G06Q 30/02

(52) U.S. Cl. CPC G06Q 30/0226
USPC 705/14.27

(57) ABSTRACT

A system and method provided for recruiting new membership through value sending from existing members. The value can be coupons, discount offers, membership points or payment vouchers in physical and/or electronic formats. The method is an active way to recruit new members through the social network of existing members. Once a member in the system sends value from their account to the non-members by simply entering his/her mobile phone number as identification of the receiver, the receiver will receive the notification through short message service (SMS) or similar service of the value received. The receiver uses his/her mobile number together with the password disclosed within the notification message for redeeming the received value at the point of purchase in the corresponding public facing business. In addition, the receiver can update his membership details through a registration webpage on the internet.

### FIELD OF THE INVENTION

The present invention relates to communication field, and more particularly relates to a new system and method for recruiting new member through sending value.

### BACKGROUND OF THE INVENTION

Due to the vigorous market competition, businesses need to develop a close relationship with their customers so as to retain customers for their products and services. Customer loyalty program has proven to be very effective way in retaining their customers and providing them with better services. Therefore, recruiting new members as many as possible has already become an important strategy to increase market share as well as maintain competitiveness in the market.

Currently, there are many ways for recruiting new members. In the most conventional way, enrollment forms are printed on paper and promoters are deployed to distribute to the general public and wait for them to fill in and submit the form back. However, it is costly as it is not efficient and environmental friendly. More shops now provide terminals located somewhere in the shop to allow customers to subscribe as members. Nevertheless, these terminal terminals are expensive, occupy floor space and require the customers to arrive at the shop for membership enrollment.

An US patent application with publication number US2009/0283582 proposes another method for solving the above problems. When a customer arrives at the shop, the customer is asked to input the personal information simply on a handheld device provided by the staff of business, in which the personal information is wirelessly transmitted to a remote system which encodes the information, sets up a new account and generate a membership card simultaneously. However, it is a passive way to recruit a new member since it can be done only when the customers arrive at the shop. Potential customers, who have not visited the shops, are excluded in the membership enrollment. Furthermore, most customers refuse to do it since they need take time in entering length personal information. Certainly, the cost of the staff and the handheld device participating in the enrollment process also increases the operation cost. What's more, the enrollment efficiency of the above methods is low because one machine fails to provide registration for several customers in parallel and a simple registration may already take several minutes.

For solving the above problem, an US patent application with publication number US2011/0057027 suggests to provide a webpage for anyone subscribing to be a member through providing personal information. However, potential members may not know where to access to the registration webpage or do not have the incentive to spend time in filling the identification information.

### SUMMARY OF THE INVENTION

The primary objective of the present invention is to provide a system and method for recruiting members in a more effective way.

More specifically, another object of the present invention to provide a system that new members are recruited from the social network of existing members through the value sending process. Additionally, new members are more likely to accept the invitation from his/her existing social network, compared with a promoter or shop assistant.

A further object of the present invention is to provide a system which gives an incentive for the non-member to be an active member through value redeeming at the point of purchase in a convenient way. When a value receiver visits the public facing business such as supermarket in utilization of the value like e-coupons, what he/she needs to do is just to identify him/herself with the mobile phone number and the password obtained from the SMS notification, and then the value can be redeemed. As the recruitment process is fully automatic, the operation cost regarding member recruitment can be lowered down. Another advantage of the present invention is that this efficient redeeming process will improve the overall shopping experience of member which ultimately increases sales of the public facing business.

In order to achieve the indicated objectives of the present invention, there is provided a membership management platform, under the operation by the operator, capable in connecting membership partners, value issuers, public facing business and members via communication network. The membership management platform according to the present invention comprises of member account management module and new member recruitment module.

According to the further aspect of the present invention, the member account management module is responsible for managing the member login, account details, purchasing and transaction issue, value or value receiving and sending. The new member recruitment module is responsible for the member recruitment issues such as registration webpage, encoding of member information, account generation and submission of notification for successful registration.

According to the further aspects of the present invention, the platform comprises one or more servers and processors, in which the servers store the program for executing the operation needed and data of members while the processors loading up the programs stored in the servers execute the operation needed. The platform can be accessed by the four abovementioned parties via communication network for any process like management of membership accounts and membership registration.

According to the further aspects of the present invention, at the membership partner and value issuer side, the receiving terminals can be servers or personal computers. At the public facing business side, the receiving terminals can be servers connecting with kiosks and point of sales terminals. At the customer side, the receiving terminals can be mobile devices or personal computers. The terminals of the four parties are connected with the platform through web service or network.

A still further object of the present invention is to provide a method for recruiting new members includes the following steps: sending value from an existing member to a non-member receiver; and recruiting the non-member receiver as a new member.

From the new members recruitment perspective of the present invention, method for recruiting new members includes the following steps: providing identification information of a value receiver; generating a membership account for the value receiver; generating notification with registration webpage and initial password; sending the notification to the value receiver; recruiting the value receiver as a new member by redeeming the value at point of sales or directly subscribing membership in the registration webpage.

According to the further aspects of the present invention, mobile phone number is used as identification due to its uniqueness across the globe.

### BRIEF DESCRIPTION OF THE DRAWINGS

The accompanying drawings illustrate one or more embodiments of the invention and, together with the written description, serve to explain the principles of the invention, and wherein:

FIG. 1 shows the system for recruiting members according to an embodiment of the present invention;

FIG. 1a shows the units within the member account management module;

FIG. 1b shows the units within the new member recruitment module;

FIG. 2 shows the membership management platform according to an embodiment of the present invention;

FIG. 3 shows the functional block diagram of the membership management platform according to a preferred embodiment of the present invention;

FIG. 4 shows equipment of membership management platform according to an embodiment of the present invention;

FIG. 5 shows the logical record structure of the membership management platform;

FIG. 6 shows the process flow in the membership login process;

FIG. 7 shows the logical data structure on the values;

FIG. 8 shows the process flow in the use of value;

FIG. 9 shows a flow chart depicting general steps regarding new membership recruitment through value sending from an existing member;

FIG. 10 shows a block diagram depicting various steps regarding value sending and membership registration operated by the operator;

FIG. 11 shows a flow chart depicting detailed steps regarding new membership recruitment through value sending from an existing member;

FIG. 12 shows flow chart depicting various steps regarding generation of SMS notification with password;

FIG. 13 shows a block diagram depicting various steps regarding value receiving, membership registration and value redeeming from a non-member;

FIG. 14 shows a flow chart depicting various steps regarding value receiving, membership registration and value redeeming from a new member;

FIG. 15 shows flow chart depicting various steps regarding membership registration at HTTPS;

FIG. 16 shows a flow chart depicting various steps regarding membership registration at HTTPS according one embodiment of the present invention.

### DETAILED DESCRIPTION OF THE PREFERRED EMBODIMENT

The below detailed description is illustrated with drawings, which form a part of detailed description. The drawings show example embodiments in which the subject matter may be practiced. These embodiments are disclosed clear enough to allow those skilled in the art to practice the subject matter. The embodiments may be combined, other embodiments may be used, or structural, logical, and electrical changes may be made but without departing the scope of the present subject matter. The following detailed description is not to be taken in a limiting sense, and the scope of the present subject matter is defined by the appended claims and their equivalents.

Before disclosing the detailed description of the present invention, the below important terms are defined in details.

As used herein in the present invention, the “virtual membership” refers to intangible information, which is generated, stored and transmitted in electronic form, for identifying a user as a member of an organization or more than one organization. The “value issuer” refers to any organizations, which generates and distribute so called “value” like coupon, value certificate, money, point, bonus, etc. These values can be in physical and/or electronics formats. The “member” refers to the individual who holds the “virtual membership” account. Members use these accounts to transact, store and maintain their transaction as well as master data.

“Public facing business” refers to organizations that operate business made available to the general public. These public facing businesses can be in the form of physical stores like supermarket, bank or cinema. They can also operate in the form of virtual store like online shopping websites.

The “membership partner” refers to both commercial organizations such as bank, airline, supermarket, department store, restaurant, hotel and non-commercial organization such as government department, which issue membership to individual. The same group of organizations can also be “public facing business” where “member” transacts “value” issued by “value issuer”.

The “membership management platform” refers to a virtual membership management system that comprises of a number of modules. Member account management module and new member recruitment module in particular are used in the present invention. The “operator” refers to an organization which is entrusted by all parties to operate the membership management platform.

As used herein in the present invention, “point of sale system” refers to terminal and/or the hardware and software used for achieving a transaction by “member” such as electronic cash registers, credit card terminals, computer sales terminals, and the like. As used herein, “point of purchase” refers to the physical or virtual location of a “public facing business” where sale of good and service take place.

As used herein, the “value” refers to money, points, coupon, etc., issued by value issuer. The value can be bought by member at public facing business at point of purchase and/or through internet. On the other hand, the value can be given to member from the value issuer as a value under any customer loyalty program. The value can be transferred to anyone under the intention of the customer.

As used herein, “existing member” regards to an individual, who is a member within the virtual membership system. “Non-member” regards to a person, not yet a member within the virtual membership system. The “potential member” means non-member applying for membership with the operator. The identification information of the application is the mobile phone number of potential member. This mobile phone number is either provided by the potential member through operator's membership recruiting and enrollment web page or by existing member.

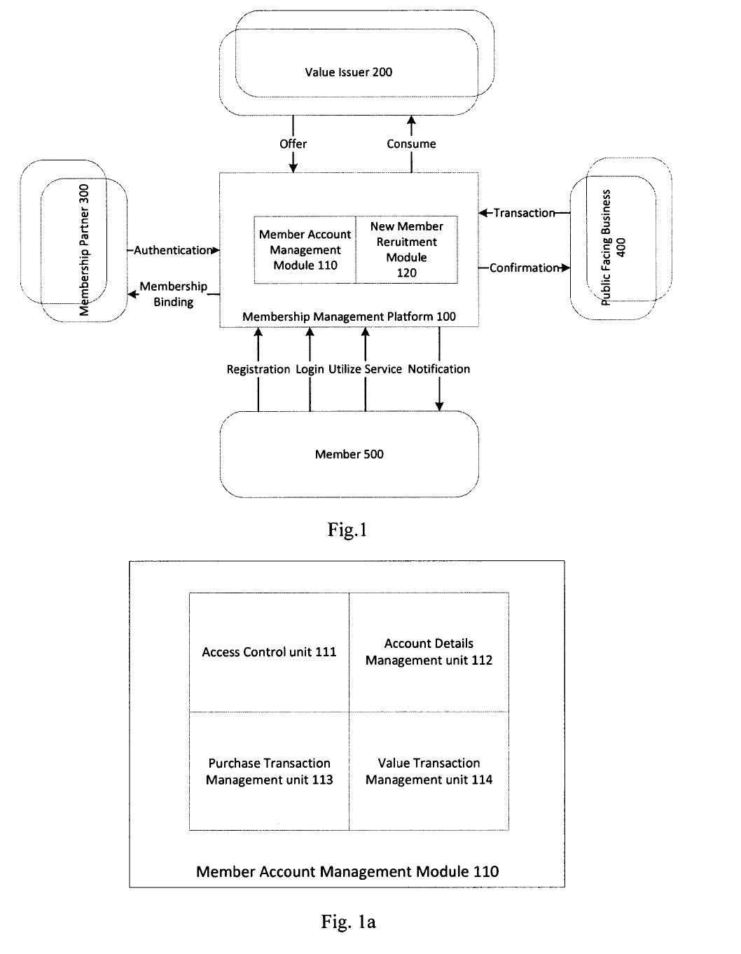

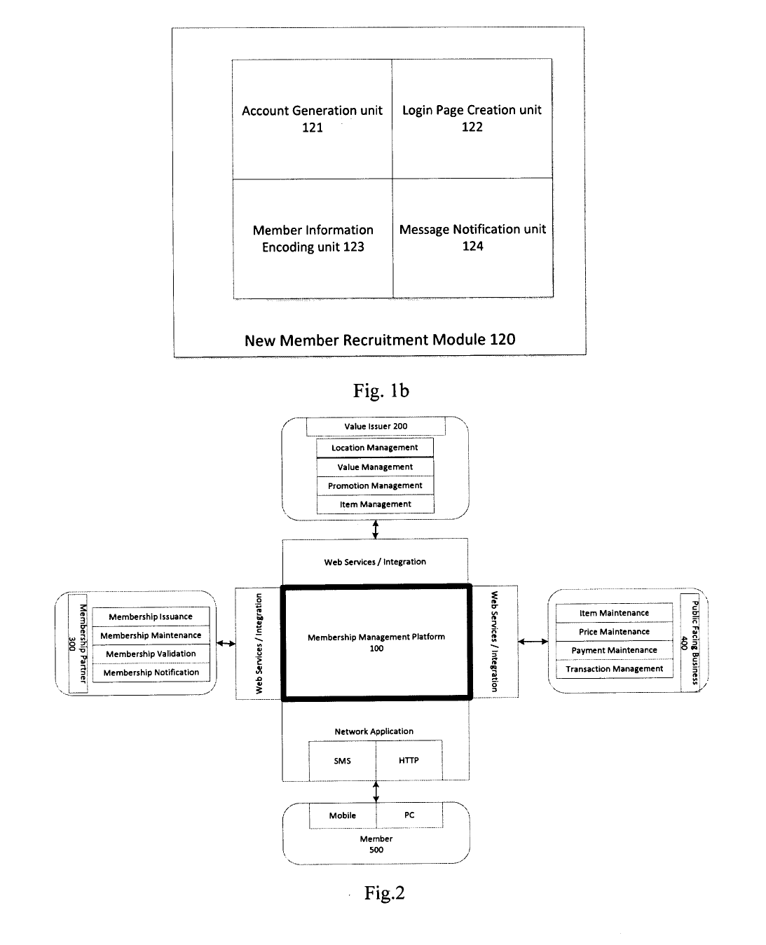

Referring to FIG. 1, there is shown a membership management platform 100 comprising of. The platform 100 is operated and managed by the operator.

The member account management module 110 is responsible for managing the member master and transaction data, and further responsible for sending value from an existing member to a non-member receiver. FIG. 1a shows the units which perform the corresponding functions within the member account management module 110. Access control unit 111 handles how the members access the system. When a member 500 types in his/her mobile phone number, the platform 100 will determine which membership partner 300 is responsible for the authentication then sends the login request. Upon successful authentication, the member 500 is given access to the system according his/her profile. Account details management unit 112 handles the information that is linked to the member 500 account. For example, if the user prefers to receive messages from SMS alternatives like iMessage or WhatsApp, he/she will input the respective selection in the profile using the account details management function. Language preference and other static information are also stored within the member's personal profile. Purchase transaction management unit 113 handles the purchase activities of the member with the public facing business 400. All transaction details are kept within the system and members have search and view functionalities to retrieve the details. Value transaction management unit 114 handles the various types of value and their movement within the member account, such as sending value from an existing member to a non-member receiver. The value can be discount offering, coupon value or points each having different expiry date and application area. Members can access to the summary of each type of value as well as the details. The module 110 also includes with security management function and system journal function being system-wide functionalities for audit and control purposes.

The new member recruitment module 120 is responsible for recruiting new member. FIG. 1b shows the units which perform the corresponding functions within the new member recruitment module 120. Account generation unit 121 handles the creation of a new member account inside the system, in which such new member is usually a non-member receiver of a value. The process will create the necessary record within the platform 100 with linkage to the membership partner 300. Information is also appended to the record to identify the current membership status. Login page creation unit 122 handles how to create and monitor unique login session for the new member. Each new member will have his/her own temporary login session created. Each login session is time-stamped with the appropriate expiry date. When a new member accesses the dedicated login page, information can be double verified. Member information encoding unit 123 identifies required language selection and encodes necessary information into the account. Message notification unit 124 handles the sending and detection message status. For example, the message notification unit 124 sends notification with registration webpage and initial password to the non-member receiver and recruits the non-member value receiver as a new member by redeeming the value at point of sales or directly subscribing membership in the registration webpage.

When new member is created, upon initial login or password change, all activities require the use of message notification, either through SMS or the preferred SMS replacement social network like iMessage or WhatsApp. The detection message status will be used to handle invalid membership creation and initiate appropriate error processing.

According to a preferred embodiment of the present invention, the operator operates and cooperates with various parties including membership partner 300, value issuer 200, public facing business 400 and member 500. FIG. 1 shows the operation of the platform 100. At first, the membership partner 300, value issuer 200, public facing business 400 and member 500 must subscribe to the operator through different channels. The operator communicates with them through the platform 100 and manages all master and transaction data between the corresponding parties through membership management platform 100.

During the membership binding process, the membership partner 300 provides the mobile phone numbers of their existing members and its account code to operator. Alternatively, if the binding is initiated from the platform 100's web page, the account code is then verified on-line with membership partner 300. If the result is positive and the entered mobile number cannot be found in the membership management platform 100, the new member recruitment module 120 communicates with the membership partner 300 to create a new account and an auto-generate password. The platform 100 will then send a notification to his/her mobile number via Short Message Service (SMS) or mobile number supported social networks such as iMessage or WhatsApp. On the other hand, if the result is positive and the entered mobile number already exists in the platform 100, the member account management module 110 will bind it under the same mobile number with an additional link to the new membership partner 300 and then send a notification to his/her mobile number via SMS or mobile number supported social network such as iMessage or WhatsApp. The membership binding will fail, if the returned result from the membership partner 300 is negative.

The membership platform 100 distributes and manages value electronically for value issuer 200, which is responsible for offering value to members 500. The platform 100 also processes earning and burning of value electronically in public facing business 400.

Finally, the operator implements services with members 500 for a series of process like membership registration, login, service utilization and notification and virtual membership account management. One of the important functions of the platform 100 is able to connect the four individual parties together. That ultimately increases the possibility for the membership partner 300 in acquiring more members 500; for the value issuer 200 to widespread its benefit and loyalty program to members; for public facing business 400 to enlarge their sales; for customers to register as members to multiple membership programs and enjoy benefits at the public facing business 400.

Furthermore, the three parties including the membership partner 300, value issuer 200 and public facing business 400 can play the role of other parties at the same time. For example, an organization can play both the roles of membership partner 300 and value issuer 200 at the same time while an organization can play the roles of value issuer 200 and public facing business 400 simultaneously.

FIG. 2 shows the system of the membership recruitment system. Membership partner 300, value issuer 200 and public facing business 400 communicate in the membership management platform 100 with the operator through web service/integration interface. Members 500 communicate with the operator through network application interface coupled to short message service (SMS), mobile phone application software such as WhatsApp and web service/HTTP. The members can use mobile phone or personal computer for connection with the network for communication with the platform. The major tasks of membership partner 300 are membership issuances, validation, maintenance and notification. The essential tasks of the value issuer 200 are location, value, promotion and item management. The major tasks of the public facing business 400 are item, price, payment and transaction management.

The portal interfaces of the membership management platform 100 are coupled to membership partner 300 portal, value issuer 200 portal and public facing business 400 portal and member 500 portal.

Through the membership partner 300 portal, the membership partner 300 can perform the following operations easily through the internet: registering as a subscriber of the virtual membership system, applying for generation of new virtual membership for customers, and managing the virtual membership.

Through the value issuer 200 portal, the value issuer 200 can perform the following operations easily through the internet: providing loyalty program, issuing point/value/coupon to any members 500 and managing the corresponding values consumption.

Through the public facing business 400 portal, the public facing business 400 can perform the following operations easily through the internet: managing payment and transaction of the members 500 at the point of purchase and consuming the value issued by value issuers 200.

Through the member 500 portal, the members 500 can perform the following operations easily through the internet: registering as a member 500 of the virtual membership system, browsing the information of the membership partner 300, value issuer 200 and public facing business 400, applying for obtaining a membership issued by a particular membership partner 300, and so on.

Through the operator self-service portal, the operator can perform the following operations easily: creating new account for the four parties, generating virtual membership for customers, managing the account information of the four parties.

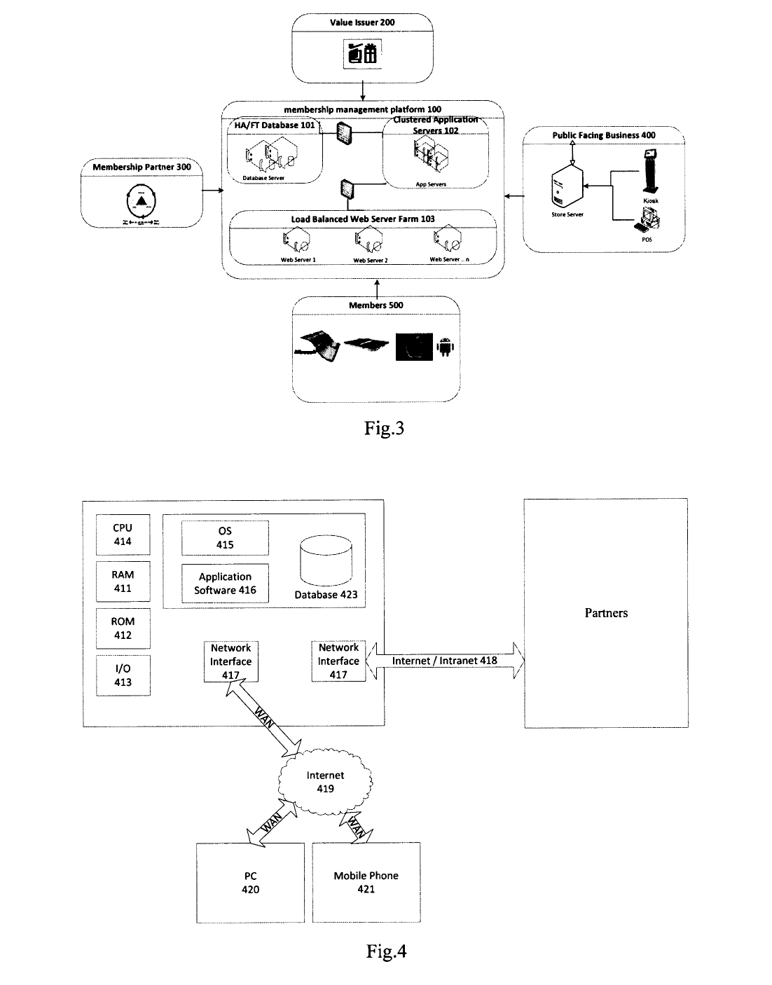

FIG. 3 shows the functional block diagram of the membership management platform 100 according to a preferred embodiment of the present invention. The membership management platform 100 comprises of High Availability (HA)/Fault Tolerant (FT) database 101, clustered application servers 102 and load balance web server farm 103. The HA/FT database 101 comprises of a series of servers. The load balanced web server farm 103 comprises of a series of web servers. At the membership partner 300 and value issuer 200 sides, there is a server or more than one server in connection with the platform 100 for membership management and value issuance management respectively. At the public facing business 400 side, there is a store server or more than one server in connection with the platform 100 that further connecting with kiosk and point of sale, POS, system. At the member 500 side, the receiving terminals are mobile phone or PC equipping with software such as Microsoft Windows, Apple Mac OS, Android Mobile OS and Apple iOS. The equipment or terminals from each party are connected with the platform 100 through web service based on TCP/IP networking.

FIG. 4 depicts a generic computing equipment of membership management platform 100 according to an embodiment of the present invention. The membership platform 100 comprises of a series of servers. In general, the computer server has a processor for controlling overall operations of the servers and its associated components, including memory like RAM 411 and ROM 412 and input/output module 413 and CPU 414. Operating system 415 and application software 416 are stored within the memory for performing various functions. Moreover, the server computer executable instructions are embodied in hardware or firmware. Database 423 may provide storage for membership information, enrolled purchasing instrument information, member benefit offer information, customer selections of member benefit offer, redeemed benefit offer data and any other suitable information. Server may operate in a networked environment supporting connections to one or more remote computers, such as terminals. Terminals may be a personal computers or servers that include many or all of the elements described above relative to server. The network connection includes a local area network, LAN and a wide area network, WAN. When used in a LAN networking environment, computer is connected to LAN through a network interface 417 or adapter. When working in a WAN environment, server may include a modem or other means for establishing communication over WAN such as internet. There are two network interfaces. One is for connection with members through wide area network, WAN, while another one is for connection with the other three partners through internet/intranet 418. For the member side, the network interface connects with the internet 419 through WAN such that the PC 420 or mobile phone 421 of the member 500 can connect with. The use of the well-known protocols such as TCP/IP, ethernet, FTP, HTTP and the like is presumed, and the system can be operated in such a way that permit users to retrieve web pages from a web-based server. Mainstream web browsers can be used to display and manipulate data on web pages.

At the public facing business 400 side, there is point of sale system comprising of computing system with corresponding hardware like processor and memory. The POS system is connected with the platform 100 for redeeming of the value such as coupons, points, etc. There are input devices at the POS system such as touch screen or keypad for entering the information for initiation of value redeeming. The entered information will be sent to the value issuer 200 for confirmation. If confirmed, the redeeming process becomes successful.

In a preferred embodiment, the platform 100 facilitates communications between a point of purchase (POP) and a remote server of the platform 100 via a custom software add-on which is integrated into the POS electronic payment system resident at the POP. The software performs many functions described in greater detail further hereinafter. The software can comprise, for example, computer-executable instructions stored on a computer readable storage medium associated with the POS electronic payment system. As a result of this integration, the public facing business 400 can communicate with the platform 100 for redeeming of the value such as coupon, points, etc.

Each point of purchase location can utilize various types of POS electronic payment system, such as credit card terminal and/or an electronic cash register (ECR), which may also further include a cash drawer, barcode scanner, receipt printer, customer facing payment terminal, touch screen, keypad, or other similar point of sales peripherals.

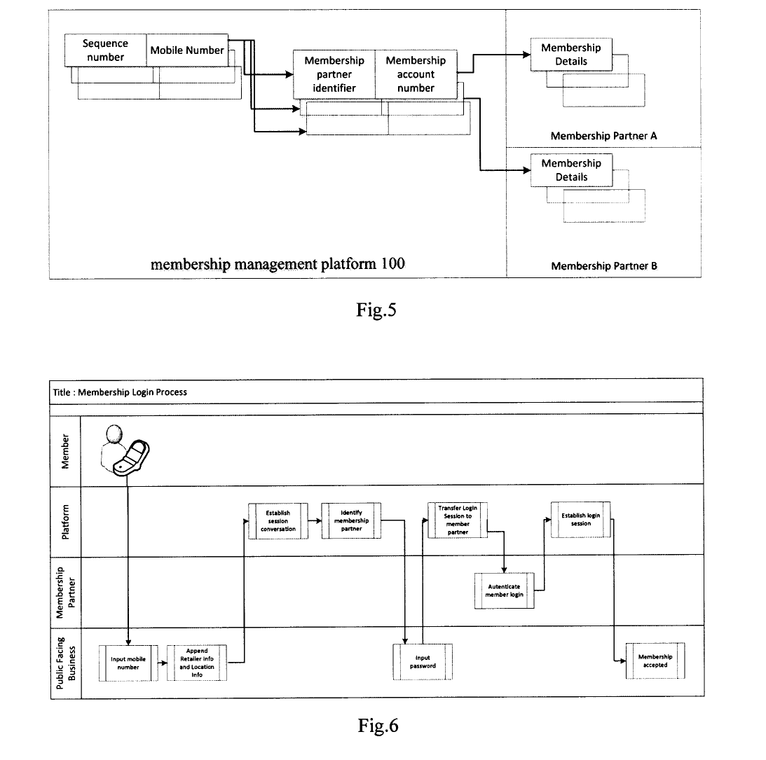

To operate with multiple membership partners 300, the membership management platform 100 is designed in such a way that a single mobile number can link to virtually unlimited number of membership partners 300. FIG. 5 shows the logical record structure of the membership management platform 100. Within each record of the virtual membership record where the mobile number is the unique identifier, multiple membership partner 300 record can be created. For each membership partner 300 record, it can then point to the associated record within the membership partner 300 structure.

FIG. 6 show the login process for the member when he/she visit the public facing business 400. During login, the member identifies himself with his mobile number. The public facing business 400 will then append her retail information and location information to form a request to the platform 100, using kiosk or point of sales (POS) system that are connected to the platform via TCP/IP network. The platform 100 will establish a secure session for future data encryption and identify that appropriate membership partner 300 with reference to the retail location information to authenticate the login session. At the public facing business side, the inputted password is encrypted according to the session created and passed onto the platform. The platform 100 will then transmit the member ID together with the encrypted password to the membership partner 300 for authentication. Upon successful login, the platform 100 will create a login session for the member and return the appropriate message to the public facing business 400 to continue the member activities with them.

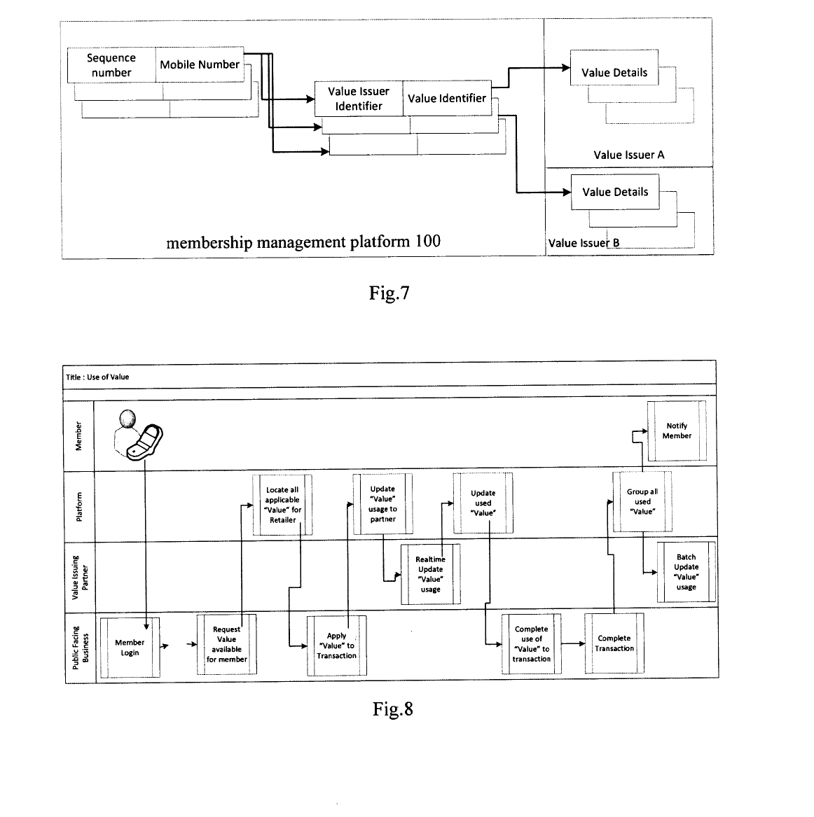

To operate with multiple value issuers 300, the following structure is deployed to store the values that are linked to each individual member 500. FIG. 7 shows the logical data structure on the values. Using the mobile number as the unique membership identifier, each mobile number can be associated with multiple value pointer records. These value pointer records will link up to each value issuer 300 who provide further information on the value details, like type, amount, expiry date, applicable location and applicable item. When the member identifies himself to the public facing business 400, the applicable values are presented to the POS system for redeeming.

FIG. 8 show the detailed flow when the member 500 utilizes his values available through the platform 100. The public facing business 400 will firstly establish a login session for the member 500 as illustrated in FIG. 6, and then process the items to be purchased by the member 500. After all the items are ready in the transaction, the POS system will raise an request to the platform 100 asking for all applicable values from the member that are appropriate to the current public facing business 400. After receiving the values from the platform, the POS system will apply them one by one. Each application of the value will update the information to the platform 100 and then to the value issuer 200. Upon complete processing all values, the POS system will complete the transaction normally and all the used values will be updated to the platform 100. The platform 100 will then notify the member 500 of the values being used as well as update the value issuer 200 for the consumption.

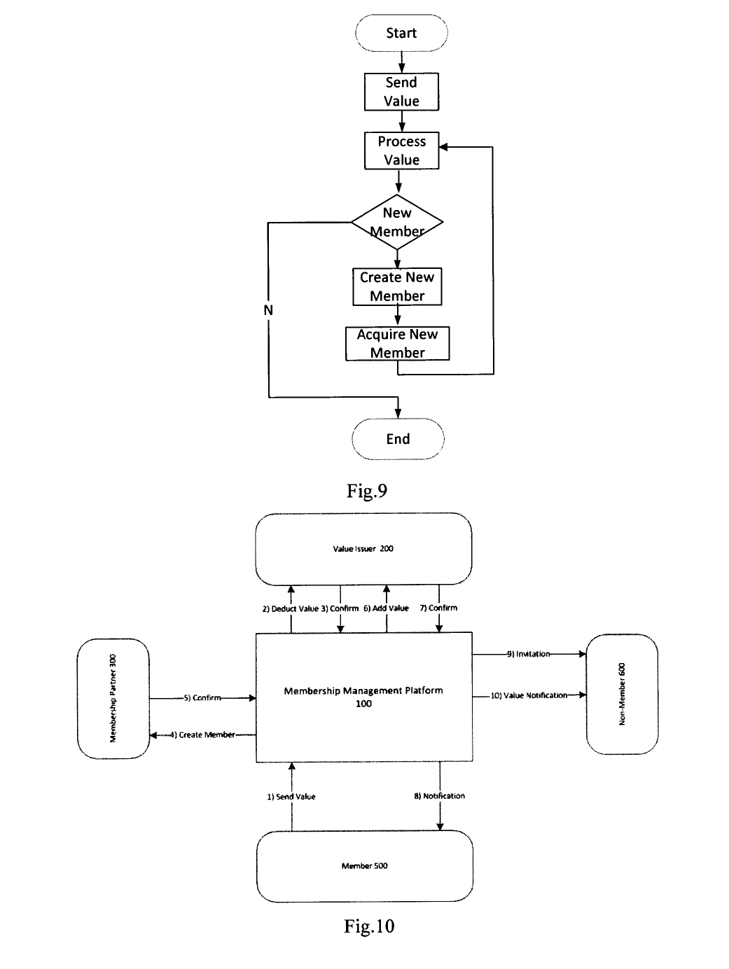

FIG. 9 illustrates a flow chart which shows the steps regarding membership recruitment through value sending from an existing member 500. At first, any member 500 in the system can send a value such as coupons issued by value issuer 200 as a value to anyone by simply inputting mobile phone number of the receiver in his/her virtual membership account. Then, the value is processed and the receiver becomes a potential member in the system of the present invention. The mobile phone number of the potential member serving as a unique identification is created in the virtual membership system. The receiver is acquired into the system and SMS is sent from the operator to the receiver for notification of value receiving. The potential member can further subscribe for membership in the registration webpage in the membership management platform 100 or start directly to use the value for purchasing at the POS of public facing business 400. Finally, the status of the potential member is changed to be an existing member 500 through this value sending process and a member 500 is recruited within the system of the present invention.

Each mobile phone has a SIM card mounted, and the SIM card is uniquely associated with a phone number. Thus, the same SIM card cannot be owned by a plurality of users at the same time, and the mobile phone number is well enough to serve as a unique identification of the potential member.

FIG. 10 shows a block diagram depicting various steps regarding value sending and membership registration operated by the operator. An existing member 500 can initiate a value sending to anyone whom he/she wish to give under the membership account management module 110. When a send value transaction is performed, the platform 100 will make an enquiry on the transfer status. Then, the value is deduced from the membership account and transferred to the account of the receiver. The value sender is notified to the transfer by a SMS sent by the operator. For sending the value to an existing member 500, the operation completes the value sent to the receiver automatically. For sending the value to a non-member 600, who does not possess any account within the membership management platform 100, the new member recruitment program under the new member recruitment module 120 will be started. Firstly, the operator will send the mobile phone number of the receiver to the membership partner 300 for notification in creating a new member account. After the authentication by the membership partner 300, an invitation message is sent to the potential member via SMS with details of the value and membership registration information. When the potential member access to the registration webpage and logs in with correct information from the SMS or directly redeems the value at the POS at the public facing business 400, he/she becomes an existing member 500.

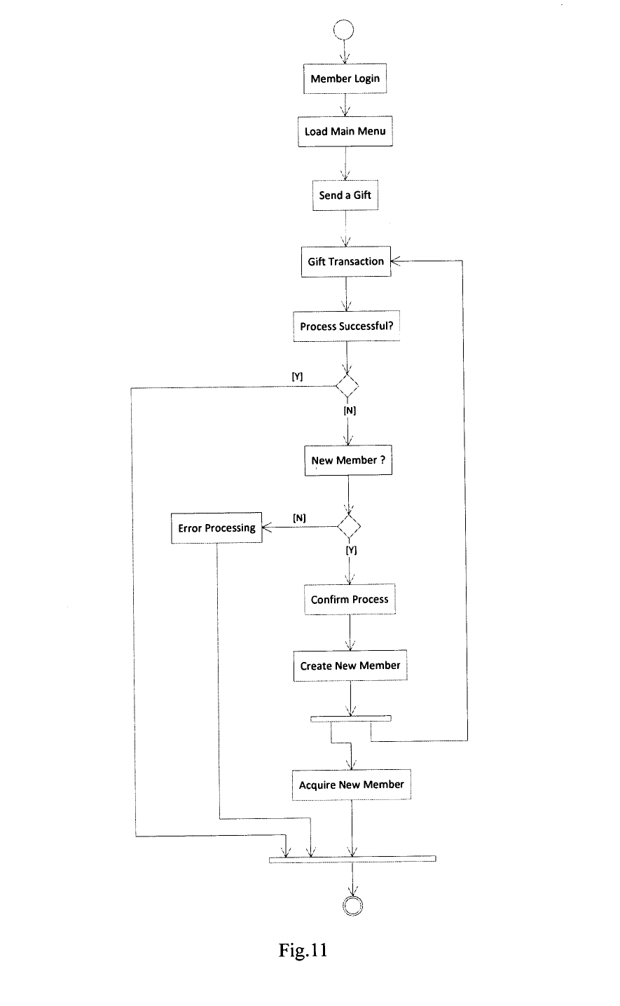

FIG. 11 shows a flow chart depicting detailed steps regarding new membership recruitment through value (such as a gift) sending from an existing member 500. Firstly, the member 500 logs in through the system web page by entering his/her mobile phone number and password under the member account management module 110. The membership partner 300 receives the request and authenticate whether he/she is a member 500 or not. If authenticated, he/she enters into his/her account with the corresponding menu and benefits displayed. The member selects any value from his/her account such as electronic coupons, points or value certificates. Then, the member 500 enters the mobile phone number of the receiver through the keyboard or any input methods. If the mobile phone number of the receiver is not found in the system, the membership management platform 100 initiates a new member creation process together with a new member recruitment process under the new member recruitment module 120. The transfer of value will now complete and both the sender and receiver will receive message regarding this transfer. When the new member utilizes the value received at the point of purchase in the public facing business 400 or logins to registration webpage generated by new member recruitment module 120, the recruitment process is completed and the potential member becomes an existing member 500.

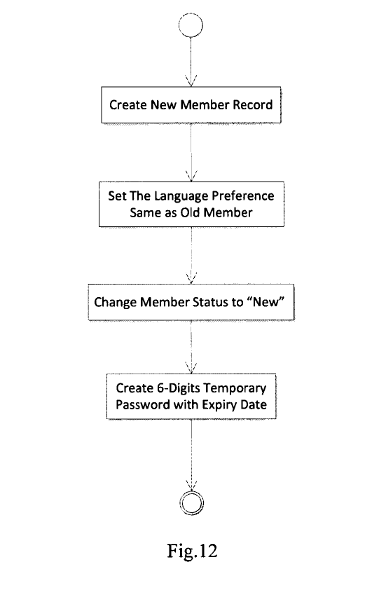

FIG. 12 shows a flow chart depicting various steps regarding generation of new membership process within the new member recruitment module 120. At first, the operator communicates with the membership partner 300 to create a new member record and set the program language preference same as the existing member 500. The member status is set to be potential and a 6-digits temporary password is generated by the membership partner 300. The custom software add-on is used to perform the above process. The server of FIG. 3 is designated for running the software required to perform the processes discussed in above.

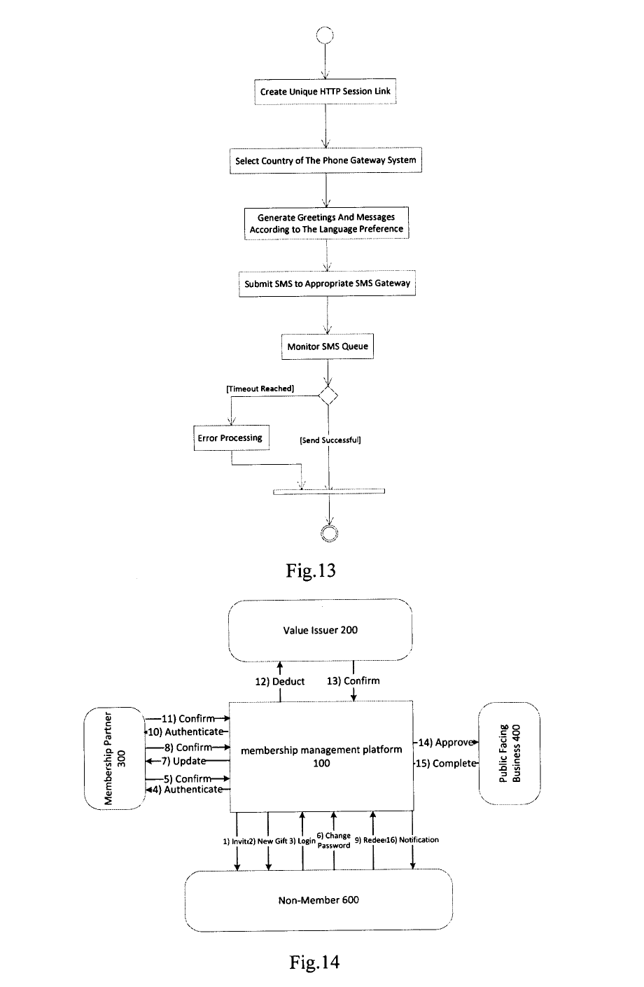

FIG. 13 shows a flow chart depicting various steps regarding generation of SMS notification with password. At first, the operator creates a unique HTTP session link and selects the country of the phone gateway system under the new member recruitment module 120. Greeting and messages according to the language are generated. The operator will submit SMS to appropriate SMS gateway and monitor SMS queue. In general, the SMS message is sent successfully to the receiver. However, if the timeout is reached, error processing appears and the message fails to be sent. The custom software add-on is used to perform the above process. The server of FIG. 3 is designated for running the software required to perform the processes discussed in above.

FIG. 14 shows a block diagram depicting various steps regarding value receiving, membership registration and value redeeming from the potential member. After the non-member 600 receives the SMS sent from the new member recruitment module 120 with instruction, initial password and web link for accessing to the web page, he/she can open the registration webpage and enter his/her mobile phone number as well as the initial password from the SMS. The membership partner 300 will validate the information given by the member 500, confirm this membership and provides feedback to the membership management platform 100. Optionally, the user can change the password for enhanced security. Without login to the registration web page, the potential member still can go to the public facing business 400 and use the mobile number and password to identify himself and then redeem the value under his account. The potential member will be notified of the completion of the transaction. Under both cases, the newly recruited member becomes an existing member 500.

Optionally, error processing will pick up cases where the newly recruited member does not sign in to the webpage or does not redeem the value within the timeframe designed. The value will be returned to the sender and both sender and receiver are notified by SMS.

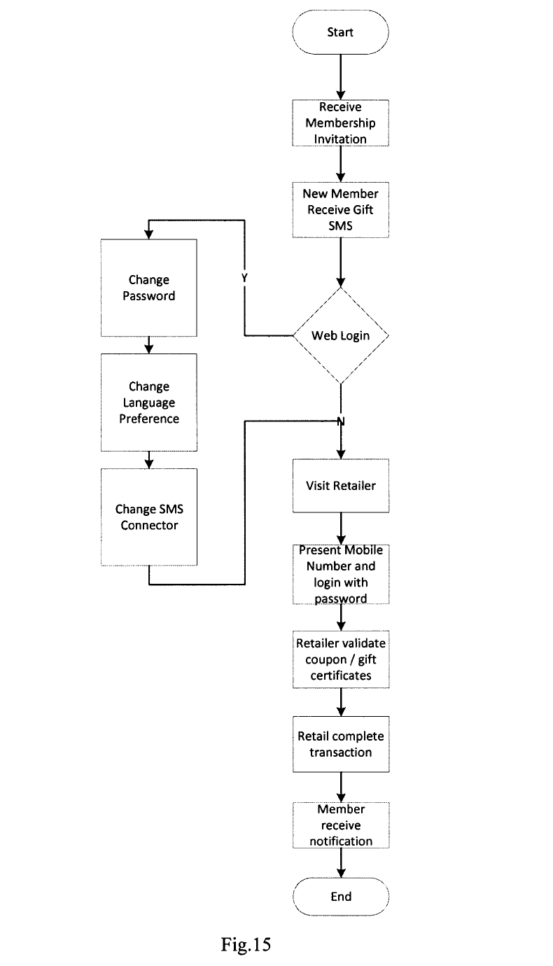

FIG. 15 shows a flow chart depicting various steps regarding value receiving, membership registration and value redeeming from a new member. Initially, the operator sends a membership invitation to the non-member 600 by SMS for informing about the value acceptance. The potential member can access to the membership registration website for web login. He/She is asked to change password, choose language preference and SMS connector. Then the potential member can visit any point of purchase of the public facing business 400 and input his/her mobile phone number and with the corresponding password at the point of sales terminal, and the value issuer 200 will validate the coupons/value certificate and complete the transaction. The operator will send a SMS to the receiver about the notification of completed transaction. After that, the potential member becomes an existing member 500.

Or in another way, without accessing the registration through the webpage, the potential member can go directly to the point of purchase of the public facing business 400 and input the mobile phone number and corresponding password at the point of sales terminals, and the value issuer 200 will validate the coupons/value certificate and complete the transaction. The non-member 600 receives a notification about completion of transaction and then his/her status changed to an existing member 500.

Furthermore, the value redeeming is not limited at the physical location of point of purchase. The value redeeming can be done at virtual store such as online shopping websites through interne shopping.

Through the above method, a member 500 is able to be recruited easily through the social network of existing members 500.

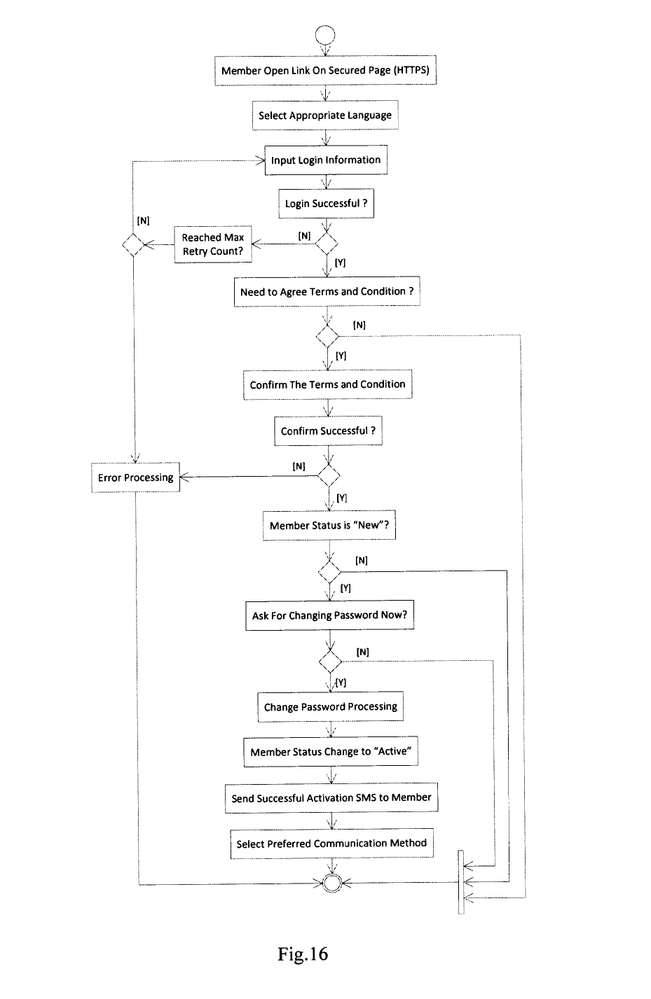

FIG. 16 shows a flow chart depicting various steps regarding membership registration at HTTPS according one embodiment of the present invention. Initially, the receiver opens the link on secured page (HTTPS) and selects the appropriate language. Then the receiver input the login information such as country code, phone number and password obtained from the SMS. Once login successfully, the receiver is asked whether to agree the terms and condition and needs to confirm it. The member status will then become “existing” from “potential”. The member 500 is asked whether to change the password now. If yes, the change of password is under processing. After the change of password, a SMS notification is sent to the mobile phone regarding the completion of registration. However, error processing will pick up the case, when the receiver fails to input with correct login information or agree with the terms.

Moreover, the present invention may be embodied as computer program product, and can be accessed from a computer readable medium. The computer readable medium provides program code for use in conjunction with computers or any other instruction executing systems. The computer readable medium may be electronic, magnetic, optical, electromagnetic, infra and semiconductor devices. The specific examples of computer readable medium include semiconductor or solid memory, magnetic tape, removable disk, random access memory (RAM), read only memory (ROM), hard disk and optical disk. The current examples of optical disk include CD-ROM, CD-R/W, and DVD, etc.

Those skilled in the art may make various modifications and changes without departing the spirit and scope of the present invention. The protection scope of the present invention shall be defined by the claims appended.

1. A method for recruiting members, comprising:
Step A, sending value from an existing member to a non-member receiver;
Step B, recruiting the non-member receiver as a new member.

2. The method for recruiting members according to claim 1, wherein, the step A further comprising:
Step A1, selecting a receiver to send value;
Step A2, inputting identification information of the receiver;
Step A3, determining whether the receiver is a non-member receiver or another existing member receiver based on the identification information;
Step A4, sending value from an account of the existing member to the non-member receiver or another existing member receiver.

3. The method for recruiting members according to claim 2, wherein, the identification information is mobile phone number.

4. The method for recruiting members according to claim 2, wherein, the Step A4 further comprising:
Step A41, creating a new account for the non-member receiver;
Step A42, sending value from the account of the existing member to the account of the non-member receiver.

5. The method for recruiting members according to claim 4, wherein, the Step A41 further comprising:
Step A411, creating a new member record for the non-member receiver;
Step A412, setting a program language preference same as the existing member;
Step A413, setting member status of the non-member receiver to be potential;
Step A414, generating a temporary password for the non-member receiver.

6. The method for recruiting members according to claim 1, wherein, the Step B further comprising:
Step B1, generating and sending an invitation message to the non-member receiver;
Step B2, recruiting the non-member receiver as a new member based on acknowledgement of the non-member receiver with the invitation message.

7. The method for recruiting members according to claim 6, wherein, the invitation message comprises notification of value receiving and/or registration webpage.

8. The method for recruiting members according to claim 7, wherein, the acknowledgement of the non-member receiver comprises use of the value for purchasing and/or subscribing for membership in the registration webpage.

9. The method for recruiting members according to claim 6, wherein, the Step B1 further comprising:
Step B11, creating a unique HTTP session link;
Step B12, selecting language preference;
Step B13, generating a greeting and invitation message according to the language preference;
Step B14, sending the greeting and invitation message to the non-member receiver.

10. The method for recruiting members according to claim 6, wherein, the Step B2 further comprising:
Step B21, obtaining an initial password and a registration webpage from the invitation message;
Step B22, validating identification information of the non-member receiver and the initial password on the registration webpage;
Step B23, recruiting the non-member receiver as a new member.

11. The method for recruiting members according to claim 6, wherein, the Step B2 further comprising:
Step B2a, obtaining an initial password from the invitation message;
Step B2b, inputting the initial password and identification information of the non-member receiver at sale terminal;
Step B2c, validating the value and completing value transaction;
Step B2d, recruiting the non-member receiver as a new member and notifying the new member.

12. The method for recruiting members according to claim 10, wherein, the Step B2 further comprising requesting the new member to changing the initial password, selecting language preference and social network connector.

13. A method for recruiting members, comprising:
Step A, selecting value from an existing member in his/her account for sending,
Step B, providing identification information of a value receiver;
Step C, generating a membership account for the value receiver;
Step D, generating notification with registration webpage and initial password;
Step E, sending the notification to the value receiver;
Step F, recruiting the value receiver as a new member by redeeming the value at point of sales or directly subscribing membership in the registration webpage.

14. The method for recruiting members according to claim 13, wherein, the identification information is mobile phone number.

15. The method for recruiting members according to claim 13, wherein, further comprising requesting the new member to changing the initial password, selecting language preference and SMS connector.

16. A system for recruiting members, comprising:
a membership management platform for managing membership which comprising:
a member account management module for sending value from an existing member to a non-member receiver;
a new member recruitment module for recruiting the non-member receiver as a new member.

17. The system for recruiting members according to claim 16, wherein, further comprising:
a value issuer for generating and distributing the value;
a membership partner for issuing the membership to individual;
a public facing business for operating business made available to general public;
wherein, portal interfaces of the value issuer, membership partner and public facing business are coupled to portal interfaces of the membership management platform.

18. The system for recruiting members according to claim 16, wherein, the member account management module comprises:
an access control unit for controlling access of an existing member;
an account details management unit for managing information linked to a member account;
a value transaction management unit for managing various type of value, and sending value from an existing member to a non-member receiver;
a purchase transaction management unit for managing purchases information.

19. The system for recruiting members according to claim 16, wherein, the new member recruitment module comprises:
an account generation unit for generating an account for the non-member receiver;
a login page creation unit for creating registration webpage and initial password;
a member information encoding unit for identifying required language selection and encodes necessary information into the account for the non-member receiver;
a message notification unit for sending notification with registration webpage and initial password to the non-member receiver and recruiting the non-member value receiver as a new member by redeeming the value at point of sales or directly subscribing membership in the registration webpage.

20. The system for recruiting members according to claim 16, wherein, membership management platform for managing membership further comprising High Availability/Fault Tolerant database, clustered application servers and load balance web server farm.
